(19) United States
(12) Patent Application Publication
(10) Pub. No.: US 2026/0253491 A1
(43) Pub. Date: Aug. 27, 2026

(54) DEVICE FOR MONITORING A PORTION OF ROAD AND FOR COUNTING PASSENGERS WITHIN VEHICLES

(71) Applicant: CYCLOPE.AI, Nanterre (FR)

(72) Inventors: Amir NAKIB, L'Hay les Roses (FR); Stéphane LOQUET, Pernes les Fontaines (FR)

(21) Appl. No.: 18/854,921

(22) PCT Filed: Apr. 6, 2023
(86) PCT No.: PCT/EP2023/059223

§ 371 Date: Oct. 7, 2024

(30) Foreign Application Priority Data
Apr. 8, 2022 (EP) 22305492.5

(51) Int. Cl. G08G 1/017; G06V 20/54; G06V 20/62; H04N 7/18

(52) U.S. Cl. CPC G08G 1/0175; G06V 20/54; G06V 20/625; H04N 7/188

(57) ABSTRACT

The invention relates to a device (D) for monitoring a portion of road, comprising a secure housing containing at least
a set of imaging apparatuses (C1, C2, C3) making it possible to obtain at least one front image, a series of side images and at least one rear image of a vehicle present in this portion;
a processing platform (T1, T2, T3) making it possible to determine an identifier of the vehicle, to match the images, to determine a number of passengers associated with the vehicle, to construct a file for said vehicle that brings together the identifier, the images and the number of passengers, and to transmit the file to a remote server (S).

### CROSS-REFERENCE TO RELATED APPLICATIONS

The present application is a filing under 35 U.S.C. 371 as the National Stage of International Application No. PCT/EP2023/059223, filed Apr. 6, 2023, entitled “DEVICE FOR MONITORING A PORTION OF ROAD AND FOR COUNTING PASSENGERS WITHIN VEHICLES,” which claims priority to European Application No. 22305492.5 filed with the European Patent Office on Apr. 8, 2022, both of which are incorporated herein by reference in their entirety for all purposes.

### FIELD OF THE INVENTION

The present invention relates to a device for monitoring a portion of road. In particular, it is designed to count the number of passengers traveling in a vehicle on a road lane.

### BACKGROUND OF THE INVENTION

Various road monitoring mechanisms exist to determine different measures of traffic or vehicles on a portion of road.

Generally speaking, however, these systems offer only partial solutions to the general problem of monitoring a portion of road, and are dedicated to a particular type of monitoring: automatic vehicle counting, license plate detection, accident detection, etc.

For example, the following Wikipedia page summarizes part of the prior art:
https://fr.wikipedia.org/wiki/Camera de surveillance routière

Many devices are designed to evaluate traffic so as to provide information to users, for example, who can take advantage of it to determine their itineraries.

However, there are no scalable, application-independent systems for monitoring a particular portion of road. Nor is there any on-board device for reliably counting the number of passengers in a vehicle.

### SUMMARY OF THE INVENTION

The aim of the invention is to provide an on-board device, which is therefore easy to deploy in the field, and which is capable on its own of determining files of detected vehicles including, in particular, a number of detected passengers associated with this vehicle.

A further advantage of the device is that it can easily be used to implement other monitoring services on the basis of the information it gathers.

To this end, the invention concerns a device for monitoring a portion of road, comprising a secure housing containing at least
a set of imaging apparatuses for obtaining at least one front image, a series of side images and at least one rear image of a vehicle present on said portion;
a processing platform for determining an identifier for said vehicle, matching said images for said vehicle, determining a number of passengers associated with said vehicle, constructing a file for said vehicle comprising said identifier, said images and said number of passengers, and transmitting said file to a remote server.

According to embodiments of the invention, this device may also comprise the following features, separately or in combination:
said processing platform is configured to detect the presence of a vehicle in a front image and then trigger said series of side images; no side images being taken in the absence of such detection;
said processing platform is configured to detect the presence of a vehicle in a rear image and then finalize said file for said transmission;
said processing platform is provided for determining said number of passengers in by subjecting at least one side image to a Yolo-type convolutional neural network;
the processing platform (T) is furthermore configured to read the license plates present in said images in order to determine license plate numbers; each of said images is associated with a time stamp, said time stamp 1 conforming to a synchronization provided by a synchronization server via an NTP protocol;
said series of side images is taken in the near-infrared;
at least said series of side images is performed in collaboration with an illuminator adapted to trigger short-duration illumination in the imaging direction and at a frequency substantially equal to that of taking images;
said processing platform is configured to detect congestion on said portion of road and, in this case, interrupt the obtaining of said series of side images;
said processing platform comprises at least one microprocessor and at least one memory containing computer code configured to operate said processing platform in collaboration with said at least one microprocessor.

The invention also relates to a system comprising a device as previously described and a display apparatus for said vehicle, wherein the information displayed on said apparatus is determined from said file.

The invention also covers a method for monitoring a portion of road, comprising
obtaining, by a set of imaging apparatuses contained in a secure housing of a device, at least one front image, a series of side images and at least one rear image of a vehicle present on said portion;
determining, by a processing platform contained in said housing, an identifier of said vehicle,
matching said images for said vehicle
determining the number of passengers associated with the vehicle,
constructing a file for said vehicle, containing said identifier, said images, and said number of passengers and
transmitting said file to a remote server.

The invention also relates to a computer program comprising instructions designed to execute the above-described method when deployed on a computer.

### BRIEF DESCRIPTION OF THE FIGURES

The device according to the invention will be described in association with the figures contained in the application:

FIG. 1 schematically shows a use case of the device according to one embodiment of the invention;

FIG. 2 schematically shows one possible architecture according to one embodiment of the invention;

FIG. 3 schematically shows a functional architecture of the device according to one embodiment of the invention.

### DETAILED DESCRIPTION OF THE INVENTION

The device according to the invention is intended to be a standalone device, that is one in which all functionalities are provided by the technical means it contains.

All that is needed to do is to position it near a portion of road, and orient it correctly so that it can fulfill its mission. It does not require any other devices with which it must cooperate. In particular, there is no need for additional cameras to obtain other viewing angles of the observed scene: the device according to the invention is self-sufficient.

It can, however, have a connection to provide monitoring results to a remote centralized server.

From a logistical point of image, the invention is easy to deploy, since all that is required is to transport the device to an operating site, without having to configure it in any way. It can therefore be quickly installed and moved by non-specialized personnel.

FIG. 1 shoes a use case wherein the monitoring device D is positioned close to a road 10 with two lanes 11, 12.

The device D can cover a portion of road defined by a longitudinal section (that is along the direction of travel) and optionally by a depth (that is a number of lanes). However, for most roads, the device D is able to cover all the lanes on a section of road. The dimensions of this coverage are mainly limited by the technology of standalone cameras.

According to the invention, the device consists of a secure housing containing a set of electronic technical means.

The primary purpose of this housing is to make the device unitary and to facilitate transport and installation. Ease of installation is important to lower the cost of deploying a large number of such devices, but also to limit the impact on roadways.

In addition, maintenance operations are facilitated by the fact that all the technical means of the device D are grouped together in a single housing.

The housing is preferentially secured to withstand weather, pollution, and vandalism. In one embodiment, the housing acts as both a support infrastructure and a technical cabinet for all the electronic technical resources (cameras, circuitry, processing platform, etc.).

It can be composed of a double-shell metal structure.

The sealed inner casing can be made mainly of aluminum. It houses all the equipment required for the connection and operation of electronic technical resources:
Technical elements for connecting, protecting, and serving electrical and computer networks;
The various local processing units are used to control the cameras, analyze images and videos, and transmit information to the remote processing unit (server).
Cameras and illuminators.

This inner casing is designed to facilitate maintenance operations by allowing easy access to the various technical means and by integrating supports that ensure complete adjustment of the sensors and preserving these settings during standard exchange operations.

The outer casing can be made of steel. It can be designed to protect against both vandalism and heat by reducing the incidence of solar radiation. It may not comprise any spaces for levers of any kind, or feature 10 mn-thick polycarbonate windows that are easy to replace, and can only be opened using screws with customizable heads. The electronic technical means comprise a set of imaging apparatuses (C1, C2, C3).

In FIG. 1, three cameras C₁, C₂, C₃ are shown, but more cameras can be provided. These cameras can be classified into three categories according to their orientation. Their respective orientations enable us to obtain at least one front image, a series of side images and at least one rear image of a vehicle present on the monitored portion. At least one camera (or apparatus) is configured to obtain at least one front image of a vehicle. In particular, the configuration includes orienting the camera so that the camera's aperture angle enables the entire front of the vehicle (that is its front face) to be captured, and in particular to obtain an image of the license plate (if the vehicle has one) with sufficient quality to enable automatic character recognition.

According to one example, the front image camera(s) C₁ enable a front image at an angle of −45° to −75° to the axis perpendicular to the road 10 passing through device D.

At least one camera (or apparatus) is configured to obtain a series of side images of the vehicle. The configuration includes orienting the camera so that its aperture angle captures the entire side of the vehicle (that is its lateral face) and, to the extent possible, all the vehicle's passengers.

In particular, the camera is preferentially offset from the axis perpendicular to the road, so as to be able to capture any passenger on the side opposite the camera, who might otherwise be concealed by a passenger on the camera side.

According to one example, the side image camera(s) C₂ allows an image to be taken at an angle of 5° to 35° to the same axis.

At least one camera (or apparatus) is configured to obtain at least one rear image of a vehicle. In particular, the configuration includes orienting the camera so that the camera's aperture angle enables the entire rear of the vehicle (wherein its rear face) to be captured, and in particular to obtain an image of the license plate (if the vehicle has one) with sufficient quality to enable automatic character recognition.

According to one example, the front image camera(s) enable a front image at an angle of ±45° to ±75° to the axis perpendicular to the road 10 passing through device D. In addition, according to one embodiment, the three cameras are positioned and oriented in relation to each other, so that no more than one vehicle can be located between their respective fields (these orientations must therefore be calculated, by simple geometric calculation, in relation to the position of the device in relation to the portion of road observed).

In FIG. 1, the triangles with one vertex corresponding to cameras C₁, C₂, C₃ illustrate, very schematically, the areas covered by those cameras.

It is understood that a vehicle traveling in the direction of the arrow on lane 12 (or in the opposite direction on lane 11) will successively enter the coverage zones of the different cameras. Occasionally, a vehicle may not be detected by one or other of the cameras, particularly when entering or exiting the lane between these coverage zones (freeway entry/exit lane, urban garage entry/exit, etc.)

According to one embodiment of the invention, the cameras are of a type that improves passenger detection inside closed vehicles, wherein through the vehicle windows. In one embodiment, the cameras can also work in conjunction with illuminators adapted to trigger short-term illumination in the imaging direction and at a light frequency substantially equal to the frequency of taking images.

When it comes to counting passengers, performance depends on obtaining images that highlight the information required: this involves visualizing the interior of vehicles in motion, through windows that are generally processed.

The aim is to provide automatic detection algorithms with images wherein humans can actually see the information they are looking for. To do this, according to one embodiment of the invention, it is sought to:
Increase the vehicle's internal contrast;
Eliminate reflections on vehicle windows, where any exist,
Have appropriate framing to minimize the concealment of both the vehicle bodywork and the passengers.

In order to obtain sufficient contrast in the image to distinguish passengers, even at night, one method consists in illuminating the interior of the vehicle through the windshield for the front image and through the side windows for the rear image.

However, an additional technical problem arises in that the majority of vehicles today have glass surfaces treated to prevent heating due to solar radiation in the passenger compartment (athermic windshields, tinted rear windows, etc.). The aim of these treatments is to limit the penetration of ultraviolet and infrared rays, and they are particularly effective for infrared rays far from the visible range.

To overcome this problem, it is proposed to combine illuminators in the visible and near-infrared range with cameras sensitive in this frequency range.

In fact, the most effective wavelength for penetrating tinted glass is far-red, at the infrared limit. This radiation is hardly visible during the day as it is mixed with sunlight, and becomes perceptible to the human eye at night. It is therefore proposed to exclude its use at night for road applications, in order to avoid disturbing passers-by, especially the driver, in favor of an invisible light located at the beginning of the infrared spectrum, in the IR-A range according to the CIE (Commission Internationale de l′Éclairage) breakdown. For example, a wavelength of 850 nm can be used. As this light is in the near-infrared range, it is invisible to the human eye and therefore does not interfere with traffic.

This can be implemented for the side camera(s) C₂ and also for the front camera C₁, both of which can be used to determine the number of passengers.

In one embodiment, the illumination is triggered for a short period of time and synchronized with the time of the image. This illumination can be pulsed. This design achieves maximum lighting efficiency while limiting power consumption and heat dissipation.

Another technical problem, mentioned earlier, is the elimination of stray reflections on the front windscreen and/or side windows.

To achieve this, a dynamic, self-adaptive process is proposed using a matrix optical sensor that natively integrates polarized monochrome filters and captures polarized light in several planes, for example four. One example is Sony's IMX250MZR sensor. The polarizations can be in equidistant directions, for example 0°, 45°, 90° and 135°. As each pixel is (for example) quadruply polarized, the invention can be implemented in such a way as to carry out suitable processing for maximum glare suppression and optimum vision of vehicle interiors. For example, for each pixel, a weighted average can be taken of the different pixel values corresponding to each polarization.

Experimentally, this method has been shown to eliminate or substantially reduce reflections on vehicle windows, thus greatly improving passenger detection and counting performance.

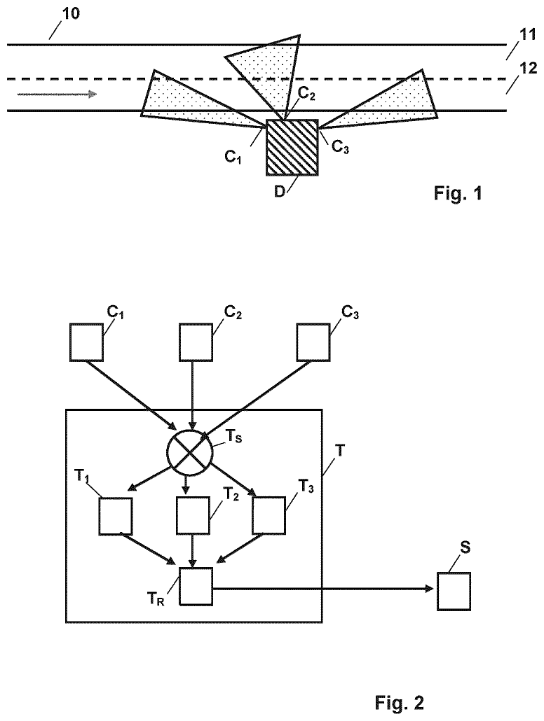

FIG. 2 schematically shows one possible functional architecture of the device D according to one embodiment of the invention.

As described above, this comprises a set of imaging apparatuses, or cameras C₁, C₂, C₃ for taking front, side and rear images of a section of road.

The image streams generated by the various cameras are transmitted to a processing platform T, contained within the same device, for local processing.

In one embodiment, the processing platform T may comprise a load balancer T_{S} and a plurality of processing elements T₁, T₂, T₃ to which the streams are distributed according to a load balancing policy implemented by the load balancer T_{S}.

In one embodiment, the stream bandwidth can vary from camera to camera. In this way, the camera(s) responsible for obtaining a series of side images can generate streams with higher bandwidths. Load balancing can follow different strategies depending on the bandwidth of the flows to be processed.

In addition, the connections between the cameras and the processing elements and load balancer can also be different from one camera to another.

For example, in a particular embodiment of the invention, the front C₁ and rear C₃ cameras transmit image streams over Ethernet connections of up to 1 Gbit/second to the load balancer T_{S}. This is connected to the various processing elements T₁, T₂, T₃ via Ethernet connections, also with a maximum data rate of 1 Gbit/second. In contrast, the side camera(s) C₂ connected directly to a T₁ processing element via a dedicated, higher-speed connection, such as a 5 Gbit/second USB connection. In this example, therefore, these streams do not pass through a load balancer (whether or not it is the same as the one used for feeds from cameras C₁ and C₃).

Processing elements T₁, T₂, T₃ perform the processing previously mentioned for some of them, which will be explained later. Such processing comprises in particular
determining an identifier for a detected vehicle,
matching the images for that vehicle,
determining the number of passengers associated with that vehicle,
and creating a file for the vehicle containing this information, wherein the identifier, all the images taken and the number of passengers

Once this processing has been carried out, the information making up the vehicle file is transmitted to a transmission element TR, which is responsible for transmitting it to a remote server S. This transmission can, for example, be a radio transmission, in order to facilitate the deployment of the device D in the field, which therefore requires no connection and no installation of a wired connection.

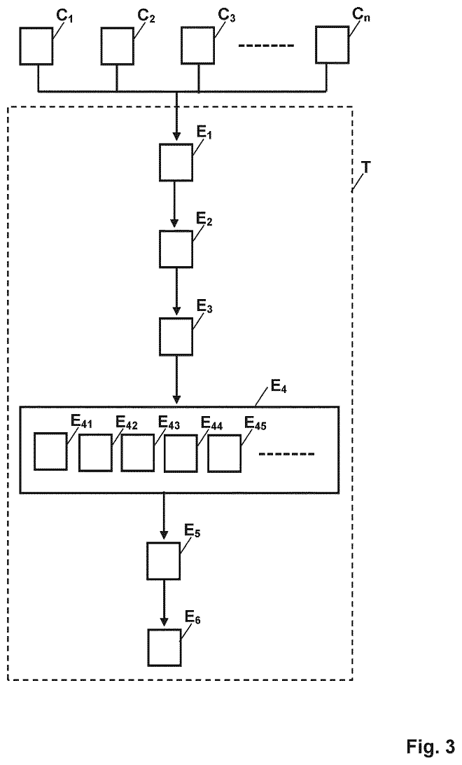

FIG. 3 shows the functional architecture of the device D, and more specifically of the processing platform T.

The functional elements E₁, E₂, E₃ . . . . E₆ are functional modules which can be implemented by specific electronic circuits, computer programs implemented on microprocessors (in collaboration with other associated circuits such as memories . . . ), or a combination thereof.

The division of the various processes into elements, or modules, is purely functional and helps to clarify the disclosure. It is clear to those skilled in the art that other functional architectures can be put in place to achieve the same technical effects, and that these can give rise to a variety of specific arrangements, particularly in terms of computer code architecture.

The element, or module, E₁, corresponds to the acquisition of image streams generated by imaging apparatuses C₁, C₂, C₃ . . . . Cₙ, where n is the number of imaging apparatuses that the device D comprises.

These images can be associated with additional information, such as the polarization information associated with each image generated by the cameras when these are polarized sensors. The generation of a processed image based on the plurality of polarized images provided by these cameras can be handled by this module.

According to one embodiment of the invention, this processing element E₁ therefore generates
images (or shots), possibly processed to remove/diminish reflections, for passenger counting in particular,
video streams (or series of images) for certain other processes.

The processing element E₁ can also control the cameras.

In particular, the side cameras C₂ can be triggered only if the front camera C₁ detects the presence or arrival of at least one vehicle, in order to reduce power consumption linked to camera activity.

More specifically, said processing platform may be provided to detect the presence of a vehicle in a front image and then trigger said series of side images; no side images being taken in the absence of such detection;

Also, according to one embodiment, a mechanism for detecting movements in the series of side images can be implemented. So, if no motion is detected, it is possible to stop shooting images until motion is detected again. This feature can be used, for example, to limit resource consumption in the event of road congestion. In this case, the vehicles are stationary, and a multiplicity of images would provide no additional relevant information compared to a single image.

According to one embodiment of the invention, this step can be carried out by first determining congestion on the supervised road segment and then, in a second step, applying an optic flow estimation algorithm to the set of digital images captured by the C₂ side imaging apparatus.

Congestion detection can be carried out by calculating a vehicle travel time between detection by, respectively, the front C₁ and rear C₃ imaging apparatuses. By determining a sharp drop in this journey time compared with a historical figure, it is easy to determine a traffic level and therefore congestion on a portion of road. To do this, one may assign detection times to vehicles on the cameras to the nearest millisecond.

An example of an optic flow estimation algorithm is the Lucas-Kanade method or the Farneback algorithm. Optic flow is the apparent motion of objects, surfaces and contours in a visual scene, caused by the relative motion between an observer (the eye or a camera) and the scene.

The concept of optic flow was studied in the 1940s, and research was published in Gibson, J. J., “The Perception of the Visual World”, Houghton Mifflin, 1950. Optic flow applications such as motion detection, object segmentation and stereoscopic disparity measurement use the movement of object textures and their edges

The processing element E₂ is configured to time-stamp each image received from the processing element E₁.

To do this, it needs to be precisely synchronized, so that each image from different cameras can be compared in time. In addition, it may be necessary to compare images from different devices D, in which case external synchronization is important. Such external synchronization can be achieved via the Network Time Protocol (NTP). The current versions of this protocol are defined by RFC 1305 and RFC 5905 of the IETF (Internet Engineering Task Force). For example, it is presented on the Wikipedia page:
https://fr.wikipedia.org/wiki/Network Time Protocol

The polling frequency of the NTP server can be set to ensure an accuracy of less than a tenth of a second in relation to this external reference.

The time stamp can be associated with each image, which is then transmitted to the E₃ processing element. This timestamp can be indicated to the nearest thousandth of a second. This precision (according to an internal reference) improves the matching operations implemented by the E₅ processing module.

Other information, in addition to the time stamp, can be associated with each image (for example by this E₂ module): identifier of the device D, sequence number, etc. Once this information has been associated with an image, it can be transmitted to a processing element E₃ . . . .

This processing element E₃. is designed to select relevant images to be sent to the various E₄ analysis modules E₄.

For example,
A license plate reading module E₄₁ will only be affected by images from the front and rear cameras (since license plates are not usually visible on images from the side camera(s)).

An initial selection can therefore be made on the basis of a criterion linked to the processing to be carried out and the origin of the images.
A passenger detection and counting module E₄₂ requires only images that have undergone appropriate pre-processing (suppression/reduction of reflections). Only images from the side cameras, and the front camera if any, need to be transmitted.

In addition, filtering can be performed on the semantic content of the images. An image in which the vehicle interior is not sufficiently visible will be unusable for the processing element E₄₂ and may therefore not be selected for transmission.

The processing element E₄ can be seen as a set of analysis elements E₄₁, E₄₂, E₄₃, E₄₄, E₄₅ . . . each specialized in a given (application) analysis. Each analysis element can therefore define specific selection criteria for the processing element E₃.

These analysis elements may or may not be present, depending on the embodiment of the invention. Other elements may also be provided in other embodiments.

One of the features of the invention is to offer a scalable platform wherein the low-level processing elements E₁, E₂, E₃ provide a diversity of enriched information from the cameras, enabling developers to design new analysis elements to take advantage of them and find a place in the set of processing elements E₄. Furthermore, as these analysis elements are essentially software, they can be deployed simply by downloading them from an external server.

The analysis element E₄₁ consists of reading the license plates on the vehicles. Front plates can be read on front images and rear plates can be read on rear images. Reading comprises detecting a license plate and then performing a character recognition step to transform this digital image area into a string of characters representing a license plate number. As will be described later, this registration number can be used as a vehicle identifier.

The analysis element E₄₂ consists in determining the number of passengers associated with the vehicles. This feature takes advantage of side images and can also take advantage of front images.

In one embodiment, this determination may comprise subjecting the images to a convolutional neural network.

This neural network can be of the Yolo type.

In one embodiment, the same image is subjected to two separate neural networks. These two networks can be of the same type (e.g. Yolo) and architectured in the same way. However, distinct learning processes have been imposed on them, so that their internal states (synaptic weights, etc.) and therefore the predictive models they represent are different.

A first neural network is configured (notably via its training) to detect regions corresponding to vehicles. A second neural network is configured to detect regions corresponding to human faces.

In one embodiment, the inferences are carried out in parallel, so that the same image is subjected to both neural networks at the same time. In the final stage, the results are matched to retain only faces detected inside the vehicles.

The two neural networks are trained by submitting as many example images of vehicles containing one or more passengers as possible. This training set should preferentially include a wide variety of images, in order to obtain robustness and accuracy in passenger detection by inference, whatever the illumination conditions (day/night), passenger location, window tint, etc.

The YOLO neural network was described in the article “You Only Look Once: Unified, Real-Time Object Detection” by Joseph Redmon, Santosh Divvala, Ross Girshick and Ali Garhadi, 2016.

In one embodiment, version 3 of the YOLO model is used. This is described in the article “YOLOv3: An Incremental Improvement” by Joseph Redmon and Ali Farhadi, 2018.

YOLO is a convolutional neural network for object detection built on the Darknet53 network, an image classifier that uses 106 layers, including 53 convolutional layers.

One of the features of YOLO version 3 is the ability to predict a region of interest (corresponding to a detected object) at three different resolutions.

After a set of sub-sampling layers (81 layers), the next layer provides a first detection at the lowest resolution. The following layers are oversampling layers. New detections are made at layers 94 and 106.

Insofar as the analysis element E₄₂ implementing these YOLO networks is to be embedded on a device D which is to be as autonomous as possible, it may be worthwhile to reduce the number of parameters of these networks.

Indeed, due to the large number of layers, a convolutional neural network such as YOLO has a large number of parameters that need to be stored in memory in order to be used in inference on images.

This excessive volume is not compatible with optimizing the processing times of the analysis module E₄₄, which consists of implementing a load-balancing mechanism. This mechanism may involve the deployment of several processes, in the microprocessor memory, each comprising an instance of the same YOLO neural networks and capable of processing concurrent streams of images. It's understandable that the volume required for each neural network is an obstacle to the multiplication of neural networks in the same memory, embedded in the device D.

In one embodiment, this problem is solved by pruning. This mechanism is described, for example, on the Wikipedia page:
https://en.wikipedia. org/wiki/Pruning (artificial neural network)

For each image, once the faces inside the vehicles have been detected, it is possible to determine the number of passengers, and thus associate a number of passengers with each vehicle detected.

The analysis element E₄₃ may consist in special processing for two-wheeled vehicles such as motorcycles.

The analysis element E₄₄ may consist in classifying the vehicles detected.

The analysis element E₄₅ may consist in detecting particular elements such as rotating beacons or cab markings, etc. This element can implement specific digital image analysis algorithms. This element can implement specific digital image analysis algorithms.

In particular, according to one embodiment, to detect rotating beacons, the images are used as these are in color while the front and side images can be monochrome. In particular, a color image is required to determine the color and status of the rotating beacons (on or off).

This information on the vehicle's class can be added to a description sheet for the detected vehicle. The presence of this information in the file can be used to implement additional processing, either on-board the device D, or outsourced to a remote server S, such as calculating statistics or detecting the presence of a vehicle in the wrong lane (private vehicles in a lane reserved for buses or cabs, etc.).

As previously explained, other analysis elements may also be present within the processing element E₄.

Each of these analysis elements can thus determine additional information. All this information can be associated with the image in question, and transmitted with it to a processing element E₅ in charge of gathering images and information concerning the same vehicle, and constructing a file for this vehicle.

All the images captured by the various cameras are matched with the information generated by the analysis modules, which are then compiled in a vehicle file. This file summarizes all the relevant data gathered by the device D.

In particular, the file may comprise a rear image. In one embodiment, the side and front images are monochrome and polarized (to facilitate passenger detection and counting). This is why it is worthwhile to have a color image of the vehicle, in order to have as complete a description of the vehicle as possible.

Generally speaking, a design wherein the device D has 3 cameras (front C₁, side C₂ and rear C₃), including a monochrome sensor with polarized filtering, offers a good compromise between limiting the resources required (to reduce cost and increase autonomy, in particular) and optimizing functionality by enabling both efficient passenger detection and a stream of color images (via the rear camera) to document the file and, possibly, perform other functions (rotating beacon detection, etc.).

This rear camera can therefore have several functions: documenting the file, detecting rotating beacons, but also registering the departure of a vehicle from the zone monitored by the device D.

It therefore appears that this design optimizes resources by enabling a minimum number of cameras to offer, through their layout, all the desired functionalities.

The matching can be carried out by the processing element in various ways.

In one embodiment, this matching comprises intra- and inter-camera vehicle tracking mechanisms.

As previously mentioned, the cameras can be positioned and oriented so that no more than one vehicle can be between the fields captured by two cameras. This makes it easier to match different cameras to the same vehicle.

If traffic is flowing freely, only one vehicle can be in the scene filmed by the side camera C₂. In such a case, tracking the vehicle through the series of images captured by this camera is easy, and it is therefore simple to group together these different images to form the corresponding vehicle file.

If traffic is not flowing smoothly, several vehicles may be simultaneously present in the images. In such cases, tracking a vehicle from one image to the next is less straightforward, but various techniques have been developed.

The paper by Erik Bochinski, Volker Eiselein and Thomas Sikora, “High-Speed Tracking-By-Detection Without Using Image Information”, International Workshop on Traffic and Street Surveillance for Safety and Security, IEEE AVSS 2017, Lecca, Italy provides an overview of various state-of-the-art solutions in this field and proposes a solution that can be implemented according to one embodiment of the invention.

This solution is based on the measurement of a Jaccard index or “Intersection Over Union” (IOU) between the bounding boxes resulting from the detection of vehicles on two consecutive images of a series of images.

Looking at the area between two detected vehicles a and b, we can define this index IOU(a,b) by the expression:

$$IOU ( a , b ) = \frac{A ( a ) ⋂ A ( b )}{A ( a ) ⋃ A ( b )}$$

where A(a) and A(b) respectively represent the area of the detected vehicle a (in a first image) and the area of the detected vehicle b (in a second image).

If the IOU(a,b) value is sufficiently high, it can be assumed that detected vehicles a and b represent the same vehicle.

Once all the information has been matched, a file is created to group them together in a single data structure.

An identifier can be assigned to this file.

If a license plate number has been determined, this number can be used as an identifier If a license plate number cannot be determined, other elements can be used to identify the file. For example, the detection index is made up of the date, time (to the nearest second), and a number associated with the vehicle's passage (e.g. YY-MM-DD-HH-mm-ss-id).

The rear camera C₃ can be used to detect the presence of a vehicle and thus finalize its registration: in fact, its detection by this camera indicates that the vehicle is moving away from the area covered by the device D and that no new information concerning it can be captured. Its file is finalized and can be sent to processing element E₆ for transmission to the remote server S.

Also, if a vehicle detected and tracked by cameras C₁ and C₂ does not appear in the image stream from the camera C₃, according to one embodiment, it can be decided to finalize its file after a given time. This given time can be predefined and correspond to an arbitrary or estimated threshold. It can also be dynamically adjusted according to an estimated vehicle speed that can be determined from the series of side images, for example.

The processing element E₆ can then transmit each file thus constructed to a remote server S.

This server S can directly or indirectly receive files from several devices D.

It may be possible to correlate information in order to match files from several devices D corresponding to the same vehicle (same identifier).

The server S can generate statistics based on the data from the device D(s): for example, number of vehicles or vehicle throughput, average number of passengers per vehicle, number of vehicles per lane, etc.

The server S can also control an apparatus for vehicle drivers. For example, an over-the-road display can be provided to present specific information for this vehicle.

In this way, the information displayed on this display apparatus can be determined from the files constructed by the device D (typically via the server S).

This information can be general, concerning traffic conditions for example.

They can also be individualized and concern a specific vehicle: For example, a vehicle not traveling in the right lane can be signaled to warn its driver (for example, a carpool lane used by a vehicle wherein a single passenger has been detected).

Since this display has to be made as quickly as possible to the drivers, it can be estimated that the processing time between capturing the images and displaying them should be around 3 seconds maximum. This constraint therefore imposes rapid processing requirements on the device D, which must implement efficient processing on-the-fly and offer a simplified architecture that not only meets these requirements, but also enables its functionalities to be upgraded.

Of course, the present invention is not limited to the examples and embodiment described and shown, but rather is subject to numerous variants within the reach of the skilled person.

1. A device (D) for monitoring a portion of road, comprising a secure housing containing at least:
a set of imaging apparatuses (C1, C2, C3) for obtaining at least one front image, a series of side images and at least one rear image of a vehicle present on said portion;
a processing platform (T1, T2, T3) for determining an identifier for said vehicle, matching said images for said vehicle, determining a number of passengers associated with said vehicle, constructing a file for said vehicle comprising said identifier, said images and said number of passengers, and transmitting said file to a remote server (S).

2. The device according to claim 1, wherein said processing platform is configured to detect the presence of a vehicle in a front image and then trigger said series of side images; no side images being taken in the absence of such detection.

3. The device according to claim 1, wherein said processing platform is configured to detect the presence of a vehicle in a rear image and then finalize said file for said transmission.

4. The device according to claim 1, wherein said processing platform is arranged to determine said number of passengers by subjecting at least one side image to a Yolo type convolution neural network.

5. The device according to claim 1, wherein the processing platform (T) is furthermore configured to read the license plates present in said images in order to determine license plate numbers.

6. The device according to claim 1, wherein each of said images is associated with a time stamp, said time stamp conforming to a synchronization provided by a synchronization server via an NTP protocol.

7. The device according to claim 1, wherein said series of side images is taken in the near-infrared.

8. The device according to claim 1, wherein at least said series of side images is performed in collaboration with an illuminator adapted to trigger short-duration illumination in the imaging direction and at a frequency substantially equal to that of taking images.

9. The device according to claim 1, wherein said processing platform is configured to detect congestion on said road portion and, in this case, interrupt the obtaining of said series of side images.

10. The device according to claim 1, wherein said processing platform comprises at least one microprocessor and at least one memory containing computer code configured to operate said processing platform in collaboration with said at least one microprocessor.

11. A system comprising a device according to claim 1 and a display apparatus for said vehicle, wherein the information displayed on said apparatus is determined from said file.

12. A method for monitoring a portion of road, comprising
obtaining, by a set of imaging apparatuses contained in a secure housing of a device (D), at least one front image, a series of side images and at least one rear image of a vehicle present on said portion;
determining, by a processing platform contained in said housing, an identifier of said vehicle,
matching said images for said vehicle,
determining the number of passengers associated with the vehicle,
constructing a file for said vehicle, containing said identifier, said images, and said number of passengers, and
transmitting said file to a remote server(S).

13. A computer program comprising instructions for executing the method of claim 12 when deployed on a computer.
